(19) United States
(12) Patent Application Publication
(10) Pub. No.: US 2003/0055761 A1
(43) Pub. Date: Mar. 20, 2003

(54) Investment and return simulation method and apparatus

(76) Inventor: Shinya Sekimoto, Mitaka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/241,722

(22) Filed: Sep. 12, 2002

(30) Foreign Application Priority Data
Sep. 14, 2001 (JP) 2001-280705

(51) Int. Cl. G06F 17/60

(52) U.S. Cl. 705/35

(57) ABSTRACT

There is disclosed a computerized method of simulating an investment and return of a merchandise having a life cycle in which a plurality of stages vary with time. A set of first parameters indicative of turning points of time is input to segment the life cycle into the plurality of stages. A set of second parameters, for the plurality of stages, is also input, which define functions of time depending patterns of an amount of investment and patterns of an amount of return. The patterns of the amount of investment and the patterns of the amount of return are connected to generate an investment model and return model throughout the life cycle. A cumulative amount of investment and also a cumulative amount of return are calculated using the investment model and return model.

### CROSS-REFERENCE TO RELATED APPLICATIONS

This application is based upon and claims the benefit of priority from the prior Japanese Patent Application No. 2001-280705, filed Sep. 14, 2001, the entire contents of which are incorporated herein by reference.

### BACKGROUND OF THE INVENTION

1. Field of the Invention

The present invention relates to an investment and return simulation method and computer program product for predicting a time-rate change in investment and return in developing or purchasing a product, service, or the like.

2. Description of the Related Art

In developing a product, service, or the like (to be generally referred to as “merchandise”, hereafter), it is a great concern for a merchandise developer to predict an investment at the time of development and a return that would be accrued when the merchandise is sold.

The same is true when a purchaser decides to buy the merchandise. It is a great concern for the purchaser to predict an investment at the time of purchase and a return that would be accrued when the merchandise is used.

This is because it can be determined that when the recovered amount (namely, “return”) by the merchandise will exceed the invested amount (namely, “investment”), development/sale or purchase of the merchandise makes sense, and conversely, if the recovered amount will be smaller than the invested amount, development/sale or purchase of the merchandise does not make sense.

Hence, a merchandise developer or purchaser predicts the investment and return before development or purchase and then determines whether actual development should be started or the merchandise should be actually purchased.

The investment and return are affected by various uncertain factors. It is not easy to strictly predict the investment and return in the future especially when quick decision-making may be required. As examples of uncertain factors in developing merchandise, no expected result may be obtained within a time limit because of the difficulty in realizing a technology, or expenses may exceed the initial budget because of imperfective material procurement. In selling developed merchandise, whether it will enjoy a large sale depends on its actual appeal to customers. The buying power for the merchandise also depends on the economic environment and the like. Such uncertain factors may generate a large error in prediction of the investment and return.

It is also difficult to form investment and return models that allow quantitative evaluation of various risks in the investment and return of merchandise to be developed or purchased.

### BRIEF SUMMARY OF THE INVENTION

The present invention has been made to solve the above problems, and has as its object to provide a method, apparatus, and computer program product for efficiency forming investment and return models in developing or purchasing merchandise and evaluating risks expected throughout the life cycle of the merchandise by reflecting them on the investment and return models.

According to embodiments of the present invention, there is provided a computerized method of simulating an investment and return of a merchandise having a life cycle in which a plurality of stages vary with time, comprising: inputting a set of first parameters indicative of turning points of time to segment the life cycle into the plurality of stages; inputting a set of second parameters, for the plurality of stages, which define functions of time depending patterns of an amount of investment and patterns of an amount of return; generating an investment model and return model throughout the life cycle by connecting the patterns of the amount of investment and the patterns of the amount of return; and calculating a cumulative amount of investment and cumulative amount of return using the investment model and return model.

According to embodiments of the present invention, there is provided a computer program product comprising: a computer storage medium and a computer program code mechanism embedded in the computer storage medium for causing a computer to simulate an investment and return of a merchandise having a life cycle in which a plurality of stages vary with time, the computer code mechanism comprising: a code segment for inputting a set of first parameters indicative of turning points of time to segment the life cycle into the plurality of stages; a code segment for inputting a set of second parameters, for the plurality of stages, which define functions of time depending patterns of an amount of investment and patterns of an amount of return; a code segment for generating an investment model and return model throughout the life cycle by connecting the patterns of the amount of investment and the patterns of the amount of return; and a code segment for calculating a cumulative amount of investment and cumulative amount of return using the investment model and return model.

According to embodiments of the present invention, there is provided a simulation apparatus for simulating an investment and return of a merchandise having a life cycle in which a plurality of stages vary with time, comprising: a first input unit configured to input a set of first parameters indicative of turning points of time to segment the life cycle into the plurality of stages; a second input unit configured to input a set of second parameters, for the plurality of stages, which define functions of time depending patterns of an amount of investment and patterns of an amount of return; a model generation unit configured to generate an investment model and return model throughout the life cycle by connecting the patterns of the amount of investment and the patterns of the amount of return; and a calculation unit configured to calculate a cumulative amount of investment and cumulative amount of return using the investment model and return model.

### BRIEF DESCRIPTION OF THE SEVERAL VIEWS OF THE DRAWING

FIG. 1 is a block diagram showing the schematic arrangement of an investment and return simulation system according to an embodiment of the present invention;

FIG. 2 is a graph showing an example of investment and return models;

FIG. 3 is a graph showing another example of investment and return models;

FIG. 4 is a view showing the arrangement of a data input window which is activated in forming investment and return models;

FIG. 5 is a view showing the arrangement of a result output window which is activated in executing investment and return simulation;

FIG. 6 is a view showing the first example of risk evaluation in the investment and return simulation system; and

FIG. 7 is a view showing the second example of risk evaluation in the investment and return simulation system.

### DETAILED DESCRIPTION OF THE INVENTION

The embodiment of the present invention will be described below with reference to the accompanying drawing.

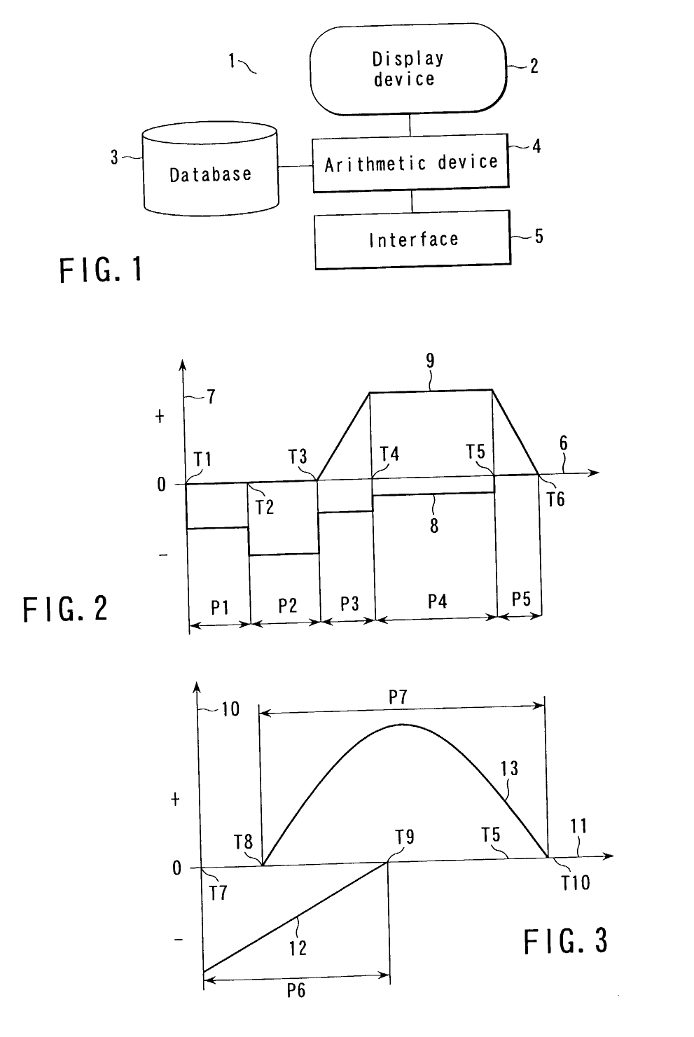

FIG. 1 is a block diagram showing the schematic arrangement of an investment and return simulation system according to an embodiment of the present invention. An investment and return simulation system 1 of the embodiment shown in FIG. 1 includes a display device 2, database 3, arithmetic device 4, and interface 5.

The database 3 serves as a storage section which accumulates various kinds of data of investment and return models. Investment and return models define the life cycle of merchandise to be simulated and investment and return patterns along the life cycle.

A “life cycle” generally consists of planning, design, manufacturing, distribution, sale, use, waste disposal, and other arbitrary stages (also referred to as phases) of given merchandise. A “life cycle form” means a form of an arbitrary stage of a life cycle.

Investment and return models include definitions of parameters and functions, which represent timings when such life cycle form changes and the amounts of investment and return for each life cycle form.

When a user or the like gives parameter values for investment and return models, the arithmetic device 4 defines the life cycle first. Investment and return patterns for each life cycle form are obtained and linked to form simple investment and return models throughout the life cycle of the merchandise. In addition, a simulation is executed by doing cumulative calculation using the resultant investment and return models and calculating financial parameters.

The arithmetic device 4 and database 3 can be implemented as computer software. In this case, hardware resources such as the arithmetic unit (e.g., CPU), bus, memory, and external storage device of a computer cooperate with the software, thereby implementing the simulation function of this embodiment.

The display device 2 displays an input editing window used to input various parameters necessary for forming investment and return models through the interface 5 or an output window for an execution result of a simulation using the formed investment and return models.

In the investment and return simulation system 1 of this embodiment, risks can easily be evaluated by altering the investment and return models. More specifically, if risk factors in investment and return are to be taken into consideration, parameters or functions defined for each life cycle form are changed. Values or definitions necessary for it are input through the interface 5.

The arithmetic device 4 re-forms the investment and return models on the basis of the alteration and re-executes the simulation using those models. The display device 2 displays and outputs a thus obtained simulation result for risk evaluation.

FIG. 2 is a graph showing an example of investment and return models. The investment and return models shown in FIG. 2 are suitable for a simulation of investment and return throughout of a life cycle in developing merchandise. Referring to FIG. 2, an abscissa 6 represents time, and an ordinate 7 represents an amount. The time uses a unit such as a day, month, quarter, half-year, or year in accordance with the life cycle of the merchandise. The amount uses a unit such as yen, 1,000 yen, 1,000,000 yen, or for a foreign market, the currency unit of the corresponding country.

In this example, the life cycle of merchandise to be developed is defined as follows. The life cycle includes five phases (stages): a planning phase P1 in which the merchandise is planned, a development/design phase P2 in which the planned merchandise is actually designed and developed, a growth phase P3 in which the developed merchandise is released and grown in a market, a mature phase P4 in which the merchandise matures in the market, and a decline phase P5 in which the merchandise becomes old-fashioned and declines. Investment and return are considered for each phase of the life cycle. Note that times T1 to T6 when the phases P1 to P5 change are defined. These parameter values are stored in the database 3.

In the graph shown in FIG. 2, reference numeral 8 denotes a change in investment in each phase of the life cycle; and 9, a change in return in each phase of the life cycle. The change 8 in investment is indicated in the fourth quadrant of the graph because the investment is represented by a negative amount. The change 9 in return is indicated in the first quadrant of the graph because the return is represented by a positive amount.

The planning phase P1 as the first stage of the life cycle has a period from T1 to T2 along the time axis. Assume that an investment in a predetermined amount takes place in this period. The investment pattern in the planning phase P1 is given by a function of time T, i.e.,

Investment (T)=M1

where M1 is the invested amount per unit time.

No return is accrued in the planning phase P1.

The development/design phase P2 as the second stage of the life cycle has a period from T2 to T3 along the time axis. Assume that an investment in a predetermined amount is made even in this period, like the planning phase P1. In this example, however, the invested amount in this period is larger than that in the planning phase P1.

The investment pattern in the development/design phase P2 is given by a function of time T, i.e.,

Investment (T)=M2

where M2 is the invested amount per unit time. No return is accrued in the development/design phase P2, like the planning phase.

The growth phase P3 as the third stage of the life cycle has a period from T3 to T4 along the time axis. At the time T3, product development is ended, and the product is released to a market (sale is started). Hence, return is accrued from this time.

Assume that return in the growth phase P3 linearly increases as time elapses. Hence, the return pattern in the growth phase P3 is given by a function of time T, i.e.,

Return (T)=α·(T−T3)

where α is the growth rate of recovered amount per unit time.

In the growth phase P3, assume that an investment is made as, e.g., merchandise delivery cost, advertisement cost, or maintenance cost. Hence, the investment pattern in the growth phase P3 is given by a function of time T, i.e.,

Investment (T)=M3

where M3 is the invested amount per unit time.

The mature phase P4 as the fourth stage of the life cycle has a period from T4 to T5 along the time axis. For return in this period, assume that the peak value in the growth phase P3 is maintained. The return pattern in the mature phase P4 is given by a function of time T, i.e.,

Return (T)=α·(T4−T3)

The investment pattern in this period is given by a function of time T, i.e.,

Investment (T)=M4

The decline phase P5 as the fifth stage of the life cycle has a period from T5 to T6 along the time axis. Assume that return in this period linearly decreases from the value in the mature phase P4 and becomes zero at the time T6. Hence, the return pattern in the decline phase P5 is given by a function of time T, i.e.,

Return (T)=α·(T4−T3) (T6−T)/(T6−T5)

Assume that no investment is done in the decline phase P5.

From the above description, the investment and return models throughout the life cycle of the merchandise are represented as follows

$$Investment ( T ) = \{ \begin{matrix}M1 & … & ( T1 \leq T < T2 ) \\ M2 & … & ( T2 \leq T < T3 ) \\ M3 & … & ( T3 \leq T < T4 ) \\ M4 & … & ( T4 \leq T < T5 ) \\ 0.0 & … & ( T5 \leq T < T6 )\end{matrix} \\ Return ( T ) = \{ \begin{matrix} 0.0 & … & ( T1 \leq T < T3 ) \\ α \cdot ( T - T3 ) & … & ( T3 \leq T < T4 ) \\ α \cdot ( T4 - T3 ) & … & ( T4 \leq T < T5 ) \\ α \cdot ( T4 - T3 ) \cdot ( T6 - T ) / ( T6 - T5 ) & … & ( T5 \leq T < T6 )\end{matrix}$$

With the above modeling, in this example, the investment and return throughout the life cycle of the merchandise can easily be expressed by using a total of 11 parameters including the six parameters T1 to T6 representing the times, the four parameters M1 to M4 representing the amounts of investment, and one parameter α representing the amount of return.

FIG. 3 is a graph showing another example of investment and return models. The investment and return models shown in FIG. 3 are suitable for a simulation of investment and return in purchasing merchandise. In the investment and return models, the life cycle of merchandise to be purchased is represented by four time parameters T7 to T10. In the graph shown in FIG. 3, reference numeral 12 denotes a change in invested amount, which is indicated by a line (linear function) having a predetermined gradient from the times T7 to T9. In this graph, reference numeral 13 denotes a change in recovered amount, which is indicated by a curve (quadratic function) from the times T8 to T10.

When these functions are introduced, the investment and return models throughout the life cycle of the merchandise to be merchandised are represented as follows.

$$Investment ( T ) = \{ \begin{matrix} β \cdot ( T9 - T ) & … & ( T7 \leq T < T9 ) \\ 0.0 & … & ( T9 \leq T < T10 )\end{matrix} \\ Return ( T ) = \{ \begin{matrix} 0.0 & … & ( T7 \leq T < T8 ) \\ γ \cdot ( T - T8 ) \cdot ( T - T10 ) & … & ( T8 \leq T < T10 )\end{matrix}$$

where β and γ are constants.

Hence, the investment and return throughout the life cycle of the merchandise can easily be expressed by using a total of six parameters including the four parameters T7 to T10 representing the times, one parameter β representing a change in investment, and one parameter γ representing the amount of return.

FIGS. 2 and 3 described above show the representative life cycle forms and investment and return patterns in developing or purchasing merchandise. Any other life cycle forms of merchandise can be considered. For the investment and return patterns as well, various patterns can be considered.

Detailed formation processing of the above-described easy investment and return models and simulation processing using the investment and return models will be described next.

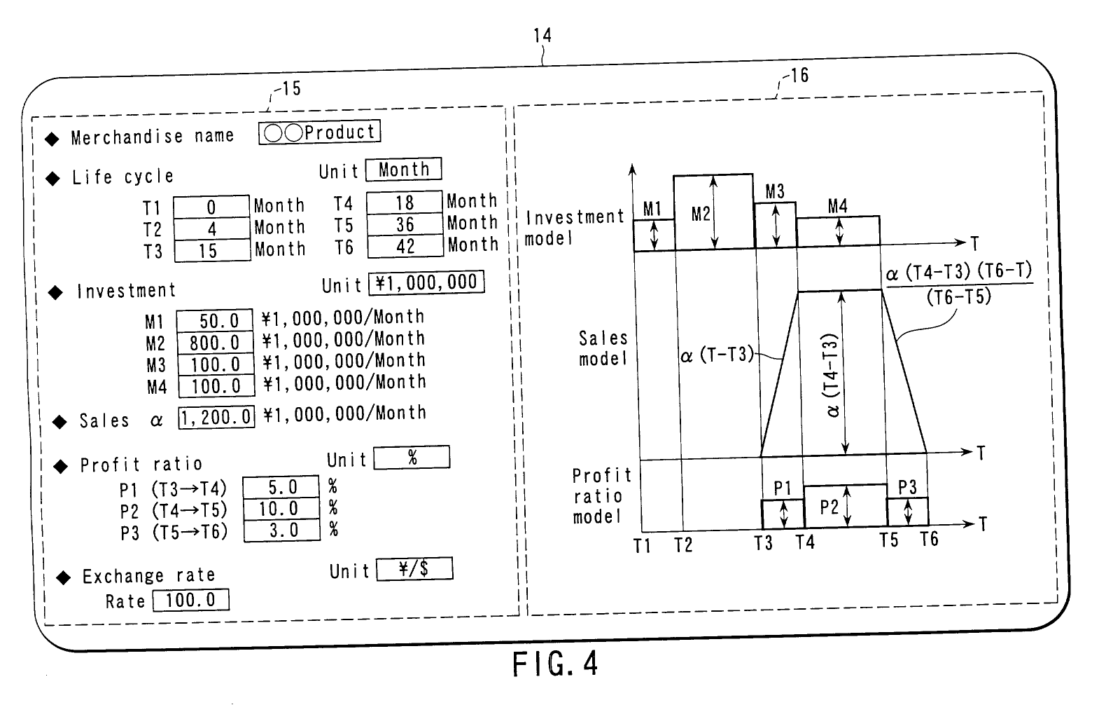

FIG. 4 is a view showing the arrangement of a data input window which is activated in forming investment and return models in the system of this embodiment. On a data input window 14, reference numeral 15 denotes a window portion for data input; and 16, a window portion indicating investment and return models. The window portion 15 has a plurality of data input items including “merchandise name”, “unit of life cycle”, “T1 of life cycle”, . . . , and Rate. These input items are prepared to define a life cycle and cause the user or the like to give parameters necessary for representing investment and return patterns in each form of the life cycle by functions and the like.

The life cycle of merchandise of this example is formed from five phases, i.e.,. the planning phase P1, development/design phase P2, growth phase P3, mature phase P4, and decline phase P5, as in the example described with reference to FIG. 2. Investment and return patterns are defined for each life cycle form of the merchandise.

In this example, instead of directly inputting the amount of return, a trapezoidal model is formed from the sales of merchandise by combining the growth, mature, and decline phases. The return is calculated by [sales]×[profit ratio] assuming that the profit ratio in each phase has a predetermined value.

Using the thus formed investment and return models, the arithmetic device 4 executes a simulation based on cumulative calculation.

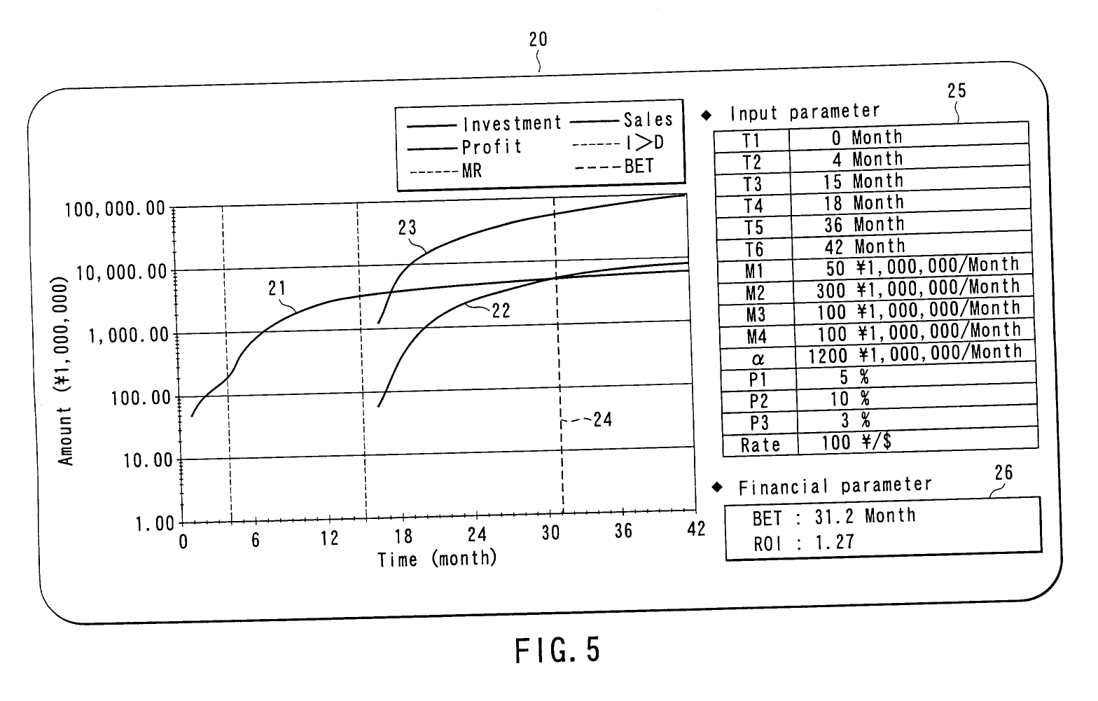

FIG. 5 is a view showing the arrangement of an output window of an execution result of investment and return simulation by the system 1 of this embodiment. As shown in FIG. 5, the cumulative graph of investment and return is displayed on a simulation execution result output window 20. The abscissa of the investment and return cumulative graph represents time, and the ordinate represents the cumulative amount. A curve 21 indicates a change in investment by a cumulative value. A curve 22 indicates a change in return (profit) by a cumulative value. A curve 23 indicates a change in sales by a cumulative value. The cumulative amounts of investment, sales, and return are largely different in number of digits. For the illustrative convenience, the cumulative values are indicated by logarithms.

As shown in FIG. 5, a window portion 25 that shows input parameters and a window portion 26 that shows the financial parameters of the BET (Break-Even Time) and ROI (Return On Investment) calculated by the simulation are displayed on the simulation execution result output window 20.

In this example, 31.2 (month) and 1.27 are obtained as the break-even time (BET) and return on investment (ROI), respectively.

At the break-even time (BET), the cumulative amount of return equals the cumulative amount of investment. When the cumulative amounts of investment and return are calculated, and the return exceeds the investment at time T=nΔT (n: an integer, and ΔT: unit time) for the first time, the break-even time (BET) can be obtained by interpolation with immediately preceding data.

$$B E T = \frac{( n - 1 ) \cdot ( {R}_{n} - {I}_{n} ) + n \cdot ( {I}_{n - 1} )}{( {R}_{n} - {R}_{n - 1} ) - ( {I}_{n} - {I}_{n - 1} )} \cdot Δ T$$

where

BET: break-even time

T: unit time

n: integer

Rn: cumulative amount of return until time T=nΔT

In: cumulative amount of investment until time T=nΔT

Rn: cumulative amount of return until time T=(n−1)ΔT

In: cumulative amount of investment until time T=(n−1)ΔT

Note that the break-even time is indicated by 24 in the cumulative graph of investment and return.

The return on investment (ROI) can be obtained by the ratio of the cumulative amount of return to the cumulative amount of investment. In the investment and return simulation system 1 of this embodiment, the return on investment when the life cycle of the merchandise is ended, i.e., at T=T6 is displayed.

Risk evaluation will be described next.

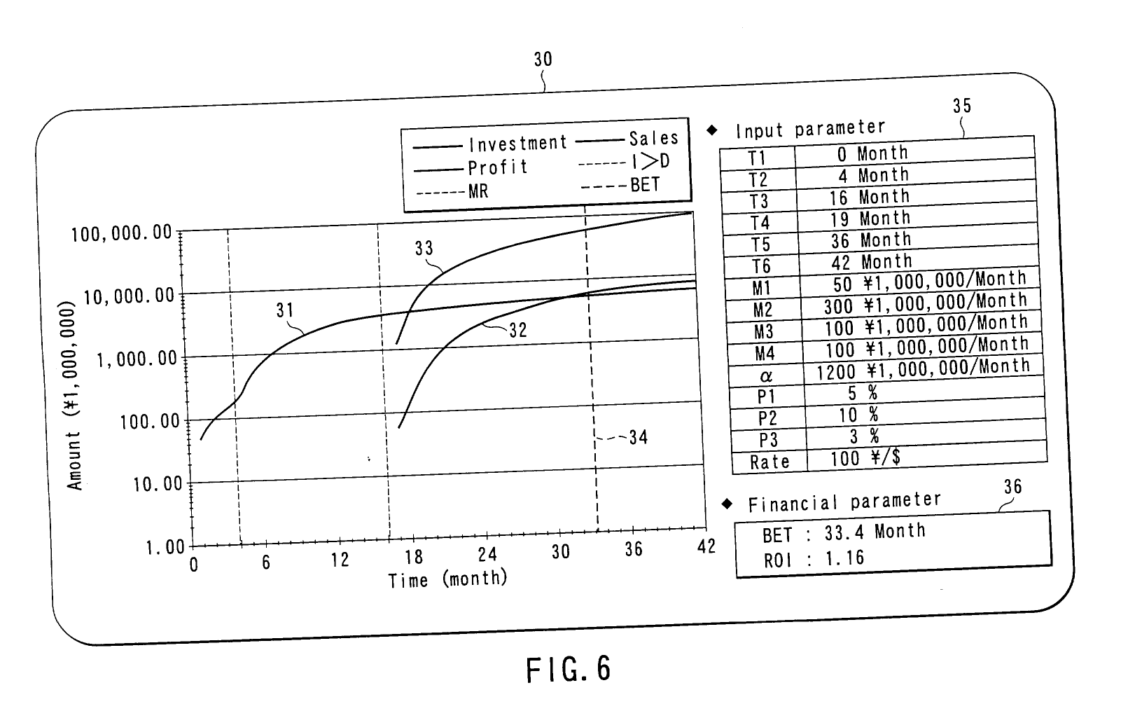

FIG. 6 is a view showing the first example of risk evaluation in the investment and return simulation system 1 of this embodiment. This example shows a simulation result when the time (T3) of start of sale is delayed by one month in the investment and return models shown in FIG. 4. On the data input window 14 shown in FIG. 4, the value of the input item T3 in the window portion 15 is changed from 15 to 16. Assuming that the length of the growth period (three months) does not change, the value of the input item T4 is changed from 18 to 19. FIG. 6 shows a simulation result output window based on the input data that has changed for the first risk evaluation.

The window arrangement is the same as in FIG. 5. A graph of cumulative investment and return is displayed on a simulation execution result output window 30. In this graph, reference numeral 31 denotes an investment change line; 32, a return (profit) change line; and 33, a sales change line. A window portion 35 that shows input parameters and a window portion 36 that shows financial parameters of the BET (Break-Even Time) and ROI (Return On Investment) calculated by the simulation are displayed on the simulation execution result output window 30. The break-even time is indicated by 34 in the graph of cumulative investment and return.

The simulation result shown in FIG. 6 is compared with that shown in FIG. 5 that considers no risks. When the start time of sale is delayed by one month, the break-even time changes from 31.2 (month) to 33.4 (month), i.e., the break-even time is delayed by two or more months. In addition, the return on investment decreases from 1.27 to 1.16 by 10% or more.

Such risk evaluation can be effectively done to quantitatively evaluate a financial loss when, e.g., the development period is prolonged more than expected due to a trouble in development.

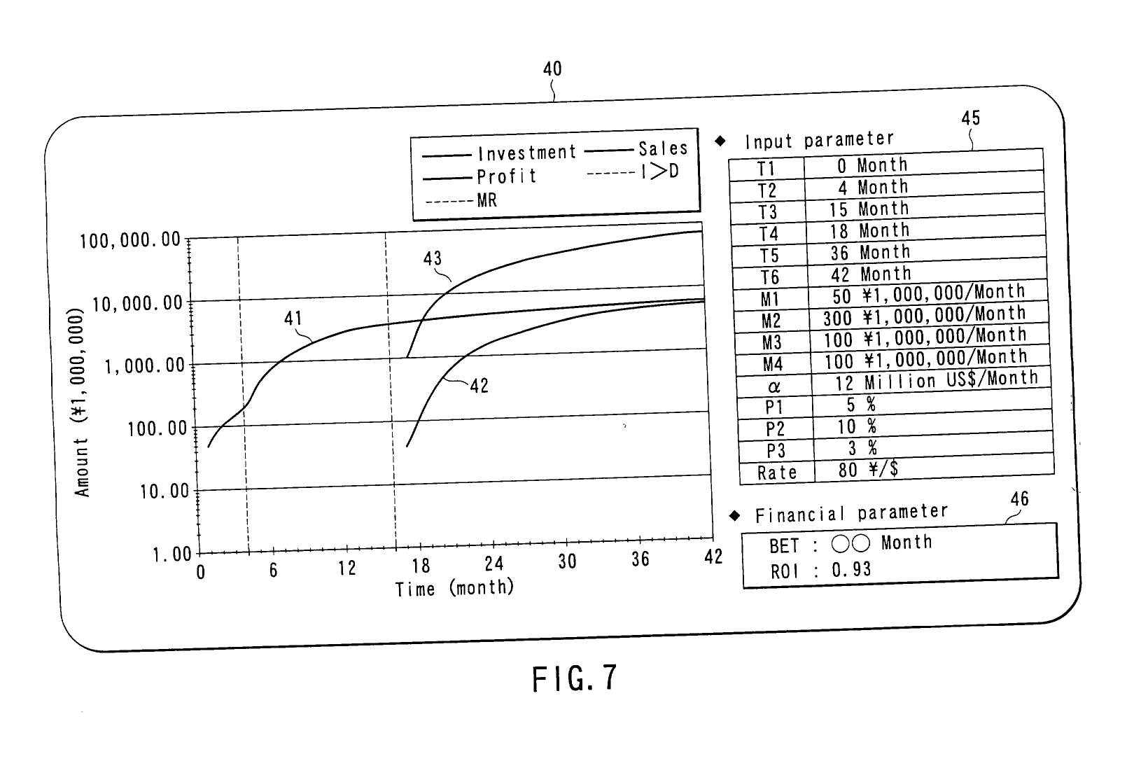

FIG. 7 is a view showing the second example of risk evaluation in the investment and return simulation system 1 of this embodiment. This example shows a simulation result when 100 ¥/$ changes to 80 ¥/$ due to the exchange fluctuation in the investment and return models shown in FIG. 4. In this case, assume that merchandise for sale in, e.g., the U.S. market is developed counting on an exchange rate of 100 ¥/$, though the rate changes to 80 ¥/$ at the time of market release. On the data input window 14 shown in FIG. 4, since the targeted market is the U.S. market, the unit of sales is changed from “¥1,000,000” to “$1,000,000”. In addition, since a rate of 100 ¥/$ is initially expected, the value of growth rate α of sales in the growth period is changed from 1,200.0 (¥1,000,000/month) to 12 ($1,000,000/month).

When a simulation is executed at this time, the same result as in FIG. 5 can be obtained. FIG. 7 shows a result obtained when re-calculation is executed after an exchange gain fluctuation for the change from 100 ¥/$ to 80 ¥/$ is given at the time of actual market release. FIG. 7 shows the output window of a simulation result based on the input data that has changed for the second risk evaluation. The window arrangement is the same as in FIG. 5. A graph of cumulative investment and return is displayed on a simulation execution result output window 40. In this graph, reference numeral 41 denotes an investment change line; 42, a return (profit) change line; and 43, a sales change line. A window portion 45 that shows input parameters and a window portion 46 that shows financial parameters of the BET (Break-EvenTime) and ROI (Return On Investment) calculated by the simulation are displayed on the simulation execution result output window 40.

According to the window portion 45 showing the input parameters, the value in the item of exchange rate changes from 100.0 to 80.0. The forms of the life cycle and profit ratio are kept unchanged regardless of the exchange fluctuation.

FIG. 7 is compared with FIG. 5. When the exchange rage changes between the time of merchandise development and the time of sale, the break-even time is ∞ (infinity). The return does not exceed the investment, and the return on investment is 1 or less.

It should be noted that the return maps indicating the cumulative investment and return by logarithms shown in FIGS. 5, 6 and 7 can be generated based on a technique of “the Hewlett-Packard Return Map” (House. C. H. and Price.R. L., “The Return Map: Tracking Product Teams, Harvard Business Review, January-February 1991, pp 92-101., the entire contents of which are incorporated herein by reference).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computerized method of simulating an investment and return of a merchandise having a life cycle in which a plurality of stages vary with time, comprising:
inputting a set of first parameters indicative of turning points of time to segment the life cycle into the plurality of stages;
inputting a set of second parameters, for the plurality of stages, which define functions of time depending patterns of an amount of investment and patterns of an amount of return;
generating an investment model and return model throughout the life cycle by connecting the patterns of the amount of investment and the patterns of the amount of return; and
calculating a cumulative amount of investment and cumulative amount of return using the investment model and return model.

2. The method according to claim 1, further comprising displaying a logarithmic graph of the cumulative amount of investment and cumulative amount of return.

3. The method according to claim 1, further comprising performing a risk evaluation in the investment or return by changing any one of the set of first parameters or changing any one of the set of second parameters.

4. The method according to claim 1, wherein at least one of the patterns of the amount of return includes a product between a constant profit ratio and a function of time of a sales amount of the merchandise.

5. The method according to claim 1, further comprising calculating a break-even time or return on investment from the cumulative amount of investment and cumulative amount of return.

6. A computer program product comprising:
a computer storage medium and a computer program code mechanism embedded in the computer storage medium for causing a computer to simulate an investment and return of a merchandise having a life cycle in which a plurality of stages vary with time, the computer code mechanism comprising:
a code segment for inputting a set of first parameters indicative of turning points of time to segment the life cycle into the plurality of stages;
a code segment for inputting a set of second parameters, for the plurality of stages, which define functions of time depending patterns of an amount of investment and patterns of an amount of return;
a code segment for generating an investment model and return model throughout the life cycle by connecting the patterns of the amount of investment and the patterns of the amount of return; and
a code segment for calculating a cumulative amount of investment and cumulative amount of return using the investment model and return model.

7. The computer program product according to claim 6, further comprising a code segment for displaying a logarithmic graph of the cumulative amount of investment and cumulative amount of return.

8. The computer program product according to claim 6, further comprising a code segment for performing a risk evaluation in the investment or return by changing any one of the set of first parameters or changing any one of the set of second parameters.

9. The computer program product according to claim 6, wherein at least one of the patterns of the amount of return includes a product between a constant profit ratio and a function of time of a sales amount of the merchandise.

10. The computer program product according to claim 6, further comprising a code segment for calculating a break-even time or return on investment from the cumulative amount of investment or cumulative amount of return.

11. A simulation apparatus for simulating an investment and return of a merchandise having a life cycle in which a plurality of stages vary with time, comprising:
a first input unit configured to input a set of first parameters indicative of separate points of time to segment the life cycle into the plurality of stages;
a second input unit configured to input a set of second parameters, for the plurality of stages, which define functions of time depending patterns of an amount of investment and patterns of an amount of return;
a model generation unit configured to generate an investment model and return model throughout the life cycle by connecting the patterns of the amount of investment and the patterns of the amount of return; and
a calculation unit configured to calculate a cumulative amount of investment and cumulative amount of return using the investment model and return model.

12. The apparatus according to claim 11, further comprising a plotting unit configured to plot a logarithmic graph of the cumulative amount of investment and cumulative amount of return on a display.

13. The apparatus according to claim 11, wherein a risk evaluation in the investment or return is performed by changing any one of the set of first parameters or changing any one of the set of second parameters.

14. The apparatus according to claim 11, wherein at least one of the patterns of the amount of return includes a product between a constant profit ratio and a function of time of a sales amount of the merchandise.

15. The apparatus according to claim 11, further comprising another calculation unit configured to calculate a break-even time or return on investment from the cumulative amount of investment and cumulative amount of return.
